(19) United States
(12) Patent Application Publication
(10) Pub. No.: US 2026/0107975 A1
(43) Pub. Date: Apr. 23, 2026

(54) A NON-CONBUSTIBLE AEROSOL PROVISION SYSTEM

(71) Applicant: NICOVENTURES TRADING LIMITED, London (GB)

(72) Inventor: Richard HEPWORTH, London (GB)

(21) Appl. No.: 19/120,455

(22) PCT Filed: Oct. 20, 2023
(86) PCT No.: PCT/GB2023/052727

§ 371 Date: Apr. 11, 2025

(30) Foreign Application Priority Data
Oct. 21, 2022 (GB) 2215600.4

(51) Int. Cl. A24D 1/20; A24B 15/167; A24F 40/20; A24F 40/46; A24F 40/465; H05B 6/10

(52) U.S. Cl. CPC A24D 1/20; A24B 15/167; A24F 40/20; A24F 40/46; A24F 40/465; H05B 6/108

(57) ABSTRACT

A non-combustible aerosol provision system including a consumable and a non-combustible aerosol provision device, the non-combustible aerosol provision device having an aerosol generator configured to heat the consumable to generate an aerosol when, in use, the consumable and the device are combined, wherein the consumable includes a hollow section, the hollow section having a support and a film of aerosol generating material coated on the support, the hollow section defining an air gap of the consumable in which aerosol is generated in use, and wherein the device includes a projection configured for insertion into the air gap of the consumable when the device and consumable are combined.

### RELATED APPLICATIONS

The present application is a National Phase entry of PCT Application No. PCT/GB2023/052727 filed Oct. 20, 2023, which claims priority to GB Application No. 2215600.4 filed Oct. 21, 2022, each of which is hereby incorporated by reference in their entirety.

### TECHNICAL FIELD

The present disclosure relates to a component for an article for use in or as an aerosol provision system, an article for use in or as an aerosol provision system and a method for forming a component for an article for use in or as an aerosol provision system.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products commonly include consumables containing aerosol generating material for use in a heating device.

### SUMMARY

In a first aspect of the present invention, there is provided a non-combustible aerosol provision system comprising a consumable and a non-combustible aerosol provision device, the non-combustible aerosol provision device comprising an aerosol generator configured to heat the consumable to generate an aerosol when, in use, the consumable and the device are combined, wherein the consumable comprises a hollow section, the hollow section comprising a support and a film of aerosol generating material coated on the support, the hollow section defining an air gap of the consumable in which aerosol is generated in use, and wherein the device comprises a projection configured for insertion into the air gap of the consumable when the device and consumable are combined.

### BRIEF DESCRIPTION OF THE DRAWINGS

Embodiments of the invention will now be described, by way of non-limiting examples only, with reference to the accompanying drawings, in which:

FIG. 1 schematically illustrates a system comprising a consumable and a non-combustible aerosol provision device;

FIG. 2 illustrates a cross section of a consumable projected onto a plane parallel to the longitudinal axis of the consumable;

FIG. 3 illustrates a cross section of a first example of the consumable of FIG. 2, projected onto a plane perpendicular to the longitudinal axis of the consumable;

FIG. 4 illustrates a cross section a second example of the consumable of FIG. 2, projected onto a plane perpendicular to the longitudinal axis of the consumable;

FIG. 5 illustrates a cross section of a consumable projected onto a plane parallel to the longitudinal axis of the consumable;

FIG. 6, illustrates a cross section of a consumable and a projection of the non combustible aerosol provision device projected onto a plane perpendicular to the longitudinal axis of the consumable;

FIG. 7, illustrates a cross section of a consumable and a projection of the non combustible aerosol provision device projected onto a plane perpendicular to the longitudinal axis of the consumable;

FIG. 8 is a flow diagram showing an example of a method of manufacturing a consumable;

FIG. 9 schematically illustrates a system comprising a consumable and a non-combustible aerosol provision device; and

FIG. 10 illustrates a consumable in combination with a tapered projection in section.

### DETAILED DESCRIPTION

As used herein, the term “delivery system” is intended to encompass systems that deliver at least one substance to a user, and includes: non-combustible aerosol provision systems that release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an aerosol-generating material heating system, also known as a heat-not-burn system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

The non-combustible aerosol provision systems described herein comprise a non-combustible aerosol provision device and a consumable for use with the non-combustible aerosol provision device.

The disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor. In some embodiments, the substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In one embodiment the active substance is a legally permissible recreational drug

In some embodiments, the active substance comprises nicotine. In some embodiments, the active substance comprises caffeine, melatonin or vitamin B12.

As noted herein, the active substance may comprise one or more constituents, derivatives or extracts of cannabis, such as one or more cannabinoids or terpenes.

The active substance may be CBD or a derivative thereof

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise one or more active substances and/or flavors, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. The aerosol-generating film may be up to 0.5 mm thick, preferably 0.05 mm to 0.5 mm microns thick. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilize at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid. The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50wt %, 60wt % or 70wt % of amorphous solid, to about 90wt %, 95wt % or 100wt % of amorphous solid.

The amorphous solid may be substantially free from botanical material. The amorphous solid may be substantially tobacco free.

The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of a pH regulators, coloring agents, preservatives, binders, fillers, stabilizers, and/or antioxidants.

The aerosol generating material may be present on or in a support, the support forming a substrate. The support may, for example, be or comprise paper, card, paperboard, cardboard, reconstituted material, a plastics material, a ceramic material, a composite material, glass, a metal, or a metal alloy. In some embodiments, the support comprises a susceptor. In some embodiments, the susceptor is embedded within the material. In some alternative embodiments, the susceptor is on one or either side of the material.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

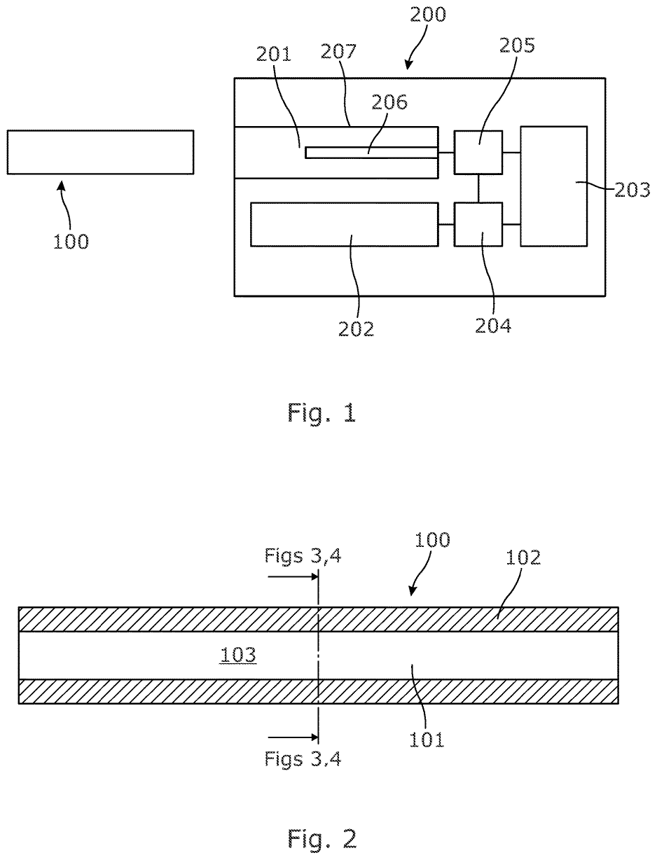

FIG. 1 illustrates a non-combustible aerosol provision system comprising a consumable 100 and a non-combustible aerosol provision device 200. The device comprises an area 201 for receiving the consumable 100 and an aerosol generator 202.

FIG. 2 illustrates the consumable 100 in cross section. The cross section is projected onto a plane that bisects the consumable in a longitudinal direction. The consumable 100 comprises a hollow section 101. The hollow section 101 comprises a wall 102 surrounding an air gap 103. The consumable 100 is configured to generate an aerosol in the air gap 103 when heated by the non-combustible aerosol provision device for inhalation by a user.

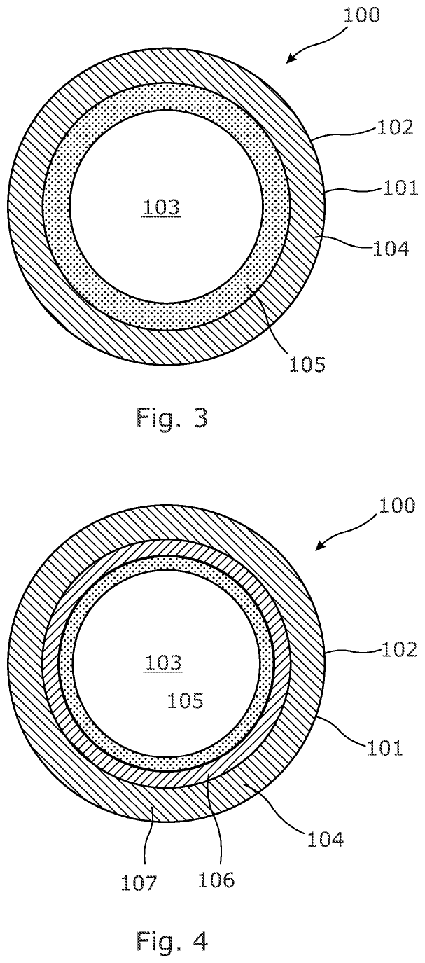

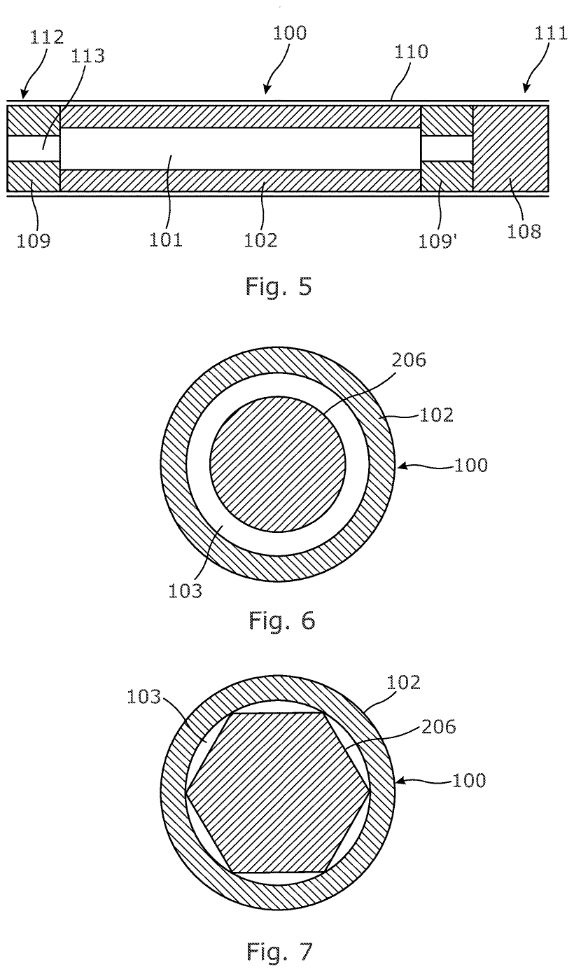

FIG. 3 illustrates the consumable 100 in a section projected onto a plane that bisects the consumable 100 perpendicular to the longitudinal direction. FIG. 3 shows further details of the wall 102 of the consumable. In the present example, the wall 102 further comprises a support 104 and a film of aerosol generating material 105 provided on the support 104. The film of aerosol generating material 105 forms an inner surface of the wall 102. The support forms an outer surface of the wall 102. In the present example, the outer surface is an outermost surface, although in other examples further layers of material may be added. In one example, illustrated by FIG. 5 and described below, the consumable 100 further comprises a wrapping material. The support may be made from any suitable material such as paper or paperboard.

FIG. 4 illustrates another example consumable 100, wherein like features retain the same reference numbers. Like FIG. 3, FIG. 4 is a section projected onto a plane that bisects the consumable 100 perpendicular to the longitudinal direction. In the example of FIG. 4, the support 104 further comprises a first layer 106 and a second layer 107, the first layer 106 being located between the aerosol generating material 105 and the second layer 107. The first layer 106 is a susceptor 106 and is heatable by penetration with a varying magnetic field. The second layer 107 is not heatable by penetration with a varying magnetic field and may be any suitable material falling within this criteria, such as paper or paperboard. The aerosol generating material 105 is provided directly on the susceptor 106. However, in other examples, further materials may be provided between the aerosol generating material and the susceptor.

In the illustrated examples, the hollow section is tubular, that is to say, comprises a circular cross section. However, it shall be appreciated that other cross sectional shapes may be used. For example, the wall may be a prism having a polygonal cross section. Example polygonal cross sections can include, but are not limited to, octagons, hexagons, heptagons or squares.

The aerosol generator 202 is configured to heat the aerosol generating material 105 of the consumable 100 when the consumable 100 is received in the area 201 for receiving the consumable. The device further comprises a power source 203, a controller 204 and a puff sensor 205. In use, a user inserts the consumable 100 into the area 201 for receiving the consumable and activates the aerosol generator 202 to generate an aerosol for inhalation. The user may then draw on a mouth end of the consumable 100 or, alternatively, on a mouthpiece (not shown) of the device 200 to inhale the aerosol. In the illustrated example, the consumable 100 and device 200 are configured so that the mouth end is a part of the consumable 100 that protrudes from the area 201 when the consumable 100 is fully inserted into the device 200. Therefore, the mouth end is available for a user to draw on the mouth-end while the user holds the device 200.

The puff sensor 205 is configured to detect when a user is drawing on the mouth end of the consumable within the device 200 and to send a signal to the controller 204 to activate the aerosol generator 202. Therefore, aerosol is generated concurrently with the user inhaling on the consumable. Alternatively, the device 200 may be provided with a user interface-such as a button (not shown)-that the user may press to cause activation of the aerosol generator 202.

The area 201 for receiving the consumable 100 is provided with an inlet (not shown) to allow air into area 201 before passing through the consumable 100 when a user draws on the mouth end 101 of the consumable 100. Therefore, a flow of air is directed through the consumable 100 when a user draws on the consumable 100. Specifically, air is directed through the air gap 103 of the hollow section 101. The flow of air entrains the aerosol generated by the aerosol generating material 105 of the consumable for inhalation by the user.

In examples of the system described herein, the device 200 comprises a projection 206. The projection 206 is configured for insertion into the air gap 103 when the consumable is inserted into the area 201 for receiving the consumable 100. The projection 206 is a column that upstands from a base of the area 201. In one example, the projection 206 has a cross sectional shape substantially the same as the cross sectional shape of the air gap 103. For example, the projection 206 may have a circular cross sectional shape for use with the circular air gaps 103 of the example consumables 100 described above. The projection is spaced from a wall 207 of the area 201 for receiving the consumable 100. Therefore, when the consumable 100 is inserted into the area 201 for receiving the consumable, the wall 102 of the consumable 100 is disposed between the projection 206 and said wall 207.

FIG. 6 shows an example of a projection 206 disposed within the air gap 103 of a consumable in cross section. The cross section is projected onto a plane that bisects the consumable 100 and projection 206 perpendicular to a longitudinal direction of the consumable 100 and projection 206. Other than the projection 206, details of the device 200 are omitted for clarity. In the example of FIG. 6, the air gap 103 and the projection 206 have a circular section. Therefore, along at least a portion of the air gap 103, the wall 102 is spaced from an outer surface of the projection 206 about the full circumference of the projection 206. In such examples, the consumable may be located within the area 201 for receiving the consumable 100 by abutment of the outermost surface of the consumable 100 with the wall 207 of said area 201. In other words, the overall diameter of the consumable 100 may be substantially equivalent to a diameter of said area 201 for tight fitting interaction of the consumable 100 in said area 201.

FIG. 7 shows another example projection 206 disposed within the air gap 103 in cross section. As in the example of FIG. 6, the cross section of the example of FIG. 7 is projected onto a plane that bisects the consumable 100 and projection 206 perpendicular to the longitudinal direction of the consumable 100 and projection 206. Again, details of the device 200 other than the projection 206 are omitted for clarity. In the example of FIG. 7, the air gap 103 has a circular section and the projection has a hexagonal section, inscribed in the circular wall 102 of the consumable 100. By ‘inscribed in the circular wall 102 of the consumable 100’, it is meant that each of the 6 apices of the hexagon abut the inner surface of the wall 102 of the consumable. In this way, the air gap 103 is divided into six segments. Also, as the projection 206 abuts the inner surface of the wall 102 of the consumable, the consumable is located within the area 201 for receiving the consumable without the outermost surface of the consumable necessarily having to abut the wall 207 of said area 201.

While the example of FIG. 7 illustrates a hexagon, it will be appreciated that projections of other cross sectional shape may be used. For example, the projection 206 may have pentagonal, square or triangular cross sectional shape. The projection 206 may, in fact take the form of any suitable prism having a polygonal cross section. In each example, the projection may be arranged so that the apices of the polygonal cross section abut the wall 102 of the consumable 102. That is to say, such polygonal prisms may be inscribed in the circular wall 102 of the consumable. Alternatively, the projection 206 may be arranged so that wall of 102 of the consumable is spaced from the projection 206 the whole way around the projection 206.

In examples described herein, the system may be configured so that the projection 206 occupies between 20% and 80% of the cross sectional area of at least a portion of the air gap 103 of the consumable 100 when the consumable 100 is fully inserted into the area 201 for receiving the consumable 100. This creates a narrowing of the air gap 103 which has a consequential effect on the pressure drop across the consumable 100 when a user draws on the consumable 100. By configuring the system so that the projection occupies between 20% and 80% of the cross sectional area of the at least a portion of the air gap 103, the system can be configured to provide a satisfactory draw resistance. In a particular example, the system may be configured to replicate the draw resistance of more traditional aerosol provision devices, such as a cigarette. In particular examples, the system may be configured so that the projection occupies between 30% and 70%, between 40% and 60% or about 50% of the cross sectional area of the at least a portion of the air gap 103. In other examples, the system may be configured so that the projection occupies about 50%, about 60%, about 70%, about 80% or about 85% of the cross sectional area of the at least a portion of the air gap 103. In the particular example of FIG. 7 in which a projection having a hexagonal projection is inscribed in the circular wall 102 of the consumable, the projection will occupy between 82% and 83% of that portion of the air gap 103. The other examples of a projections 206 having a polygonal cross sections inscribed by a circular wall 102 of the consumable are also considered to be within the scope of this disclosure.

The projection 206 may have a constant cross sectional area along its length, or the cross sectional area may vary along its length. In one example, the cross sectional area of the projection gets smaller along its length, that is to say, the cross sectional area gets smaller with distance from the base of the area 201 for receiving the consumable 100. In other words, the projection 206 may be tapered as schematically illustrated by FIG. 9. In such examples, the percentage of the cross sectional area of the air gap 103 that the projection 206 occupies when the consumable 100 is fully inserted into the area 201 varies along the length of the hollow section 101 of the consumable 100. In one example, the percentage of the cross sectional area of the air gap 103 that the projection 206 occupies may be around 80% near the base of the area 201 and around 10% near a tip 208 of the projection 206. In another example, the projection 206 has a constant cross sectional area along its length and is configured to extend only partially along the length of the hollow section 101 when the consumable 100 is fully inserted in the area 201. Therefore, the projection 206 occupies a percentage of the cross sectional area of the air gap 103 only where the projections extends, with the air gap 103 extending beyond the projection 206 so that at least a portion of the air gap 103 is free of the projection 206.

The aerosol generator 202 comprises any suitable means for heating the aerosol generating material 105 of a consumable 100 received in said area 201 of the device 200. Power for the aerosol generator 202 is provided by the power source 203, which in the illustrated example is an electrical power source 203, such as a battery 203.

In one example, the aerosol generator 202 comprises a magnetic field generator configured to generate a varying magnetic field that penetrates the area 201 for receiving the consumable 100. Therefore, the device 200 is configured for use with the consumables 100 comprising a susceptor, such as the consumable exemplified by FIG. 3. The varying magnetic field heats the susceptor 106 by magnetic hysteresis. When the consumable 100 is placed within the device 200 and the aerosol generator 202 is activated, a varying magnetic field penetrates the susceptor 106 of the consumable 100 and causes heating of aerosol generating material 105 in thermal contact with the susceptor, generating an aerosol for inhalation by a user.

In another example, the aerosol generator 202 comprises a susceptor in thermal contact with the area 201 for receiving the consumable 100; and a magnetic field generator for generating a varying magnetic field that penetrates the susceptor. The varying magnetic field heats the susceptor by magnetic hysteresis. The susceptor in turn heats the area 201 for receiving the consumable. Therefore, when a consumable 100 is placed within the device 200 and the aerosol generator 202 is activated, a varying magnetic field penetrates the susceptor and causes heating of area 201 in which the consumable 100 is received. The heat is transferred to the aerosol generating material 105 of the consumable 100, generating an aerosol for inhalation by the user. In such examples, the wall 207 of the area 201 for receiving the consumable 100 may comprise the susceptor. The consumable 100 may be configured for direct contact with the wall 207 for efficient heat transfer. Alternatively, or additionally, the projection 206 may comprise the susceptor. For example, either or both of the wall 207 and the projection 206 may be made from a material that can be heated by penetration with a varying magnetic field.

In examples described herein, the system may be configured so that the projection 206 occupies between 50% and 80% of the volume of the air gap 103 when the consumable 100 is fully inserted into the area 201 for receiving the consumable 100. By configuring the system so that the projection occupies between 50% and 80% of the volume of the air gap 103, the system can be configured to provide a satisfactory draw resistance. In the particular example in which the projection 206 comprises the susceptor, configuring the system so that the projection occupies between 50% and 80% of the volume of the air gap 103, ensures a satisfactory balance between draw resistance and the level of heating provided within the air gap 103. In other examples, the system may be configured so that the projection occupies about 50%, about 60%, about 70%, about 80% or about 85% of the volume of the air gap 103 when the consumable 100 is fully inserted into the device 200.

In another example, the aerosol generator 202 comprises a material heatable by electrical conduction, the material being provided in thermal contact with the area 201 for receiving the consumable 100. Therefore, when a consumable 100 is placed within the device 200 and the aerosol generator 202 is activated, a current is passed through the material to heat area 201 in which the consumable 100 is received. The heat is transferred to the aerosol generating material 105 of the consumable 100, generating an aerosol for inhalation by the user. In such embodiments, the material may be the wall 207 of the area 201 for receiving the consumable 100 and the consumable 100 may be configured for direct contact with the wall 207 for efficient heat transfer.

In any of the above examples of aerosol generator 202, the aerosol generator 202 may be configured for zonal or sectional heating of the consumable 100. By ‘zonal or sectional heating’ it is meant that the aerosol generator 202 is configured to heat discreet portions of the aerosol generating material 105 separately, that is to say, at different points in time. Zonal heating may be provided in a device 200 comprising a projection 206 having a cross sectional area that varies along its length, as described above.

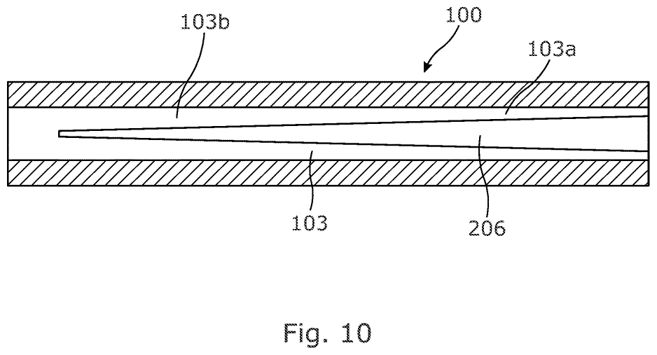

An example consumable 100 in combination with a tapered projection 206 is shown in section in FIG. 10, other features of the device 200 are omitted for clarity. The device 200 is configured for zonal heating. The device is configured to heat a first discreet section 103a of the consumable air gap 103 prior to a second discreet section 103b or to heat the second discreet section 103b prior to the first discreet section 103a. Whether or not the first or second discreet section 103a, 103b is heated first may depend on a user input, or may be inherent in the device 200 configuration. The first discreet section 103a is axially spaced from the second discreet section 103b and may comprise the same or a different aerosol generating material 105. The first discreet section 103a is relatively closer to the base of the projection 206 than the second discreet section 103b. Because the projection 206 occupies a greater percentage of the volume of the first discreet section 103a than it does the second discreet section 103b, the first discreet section 103a may be heated faster than the second discreet section 103b. Also because of the difference in volume of the first and second discreet sections 103a, 103b occupied by the projection 206, the aerosol formed in the first discreet section 103a when heated may be different to the aerosol formed in the second discreet section 103b when heated. The aerosol generating material 105 provided in the first and second discreet sections 103a, 103b may be selected as appropriate to make best use of these different aerosol generating characteristics. A non-combustible aerosol provision system may therefore be designed to give a user an experience that changes during heating of the consumable 100. In particular, the user's experience of the consumable 100 during heating of the first discreet section 103a may be different to their experience of the consumable 100 during heating of the second discreet section 103b.

It will be appreciated that, while the example above describes zonal heating of two discreet sections 103a, 103b of a consumable 100, zonal heating may be applied to any number of discreet sections as required. The skilled person will appreciate that the consumable 100 may be divided up into any number of discreet sections and that device 200 may be correspondingly configured to heat each of said discreet sections separately.

The consumable 100 may be provided with any number of additional components for attachment to the hollow sections 101 described above. Importantly however, any additional components must not impede insertion of the projection 206 into the air gap 103 when the consumable 100 and the device 200 are combined. An example consumable 100 with additional components is shown in FIG. 5, in which example the consumable comprises a filter plug 108 and two locator components 109, 109′in addition to the hollow section 101. The additional components 108, 109, 109′ comprise an outside diameter substantially the same hollow section 101 and are connected thereto in axial alignment by a wrapping material 110. The consumable comprises a mouth end 111 and a distal end 112. The distal end 112 is configured for insertion into the area 201 for receiving the consumable 100. In all examples of consumables 100 falling within the scope of the present disclosure, the distal end 112 comprises an opening 113 to allow the projection 206 to pass into the air gap 103 of the hollow section 101. This opening may be an open end of the hollow section 101—for example, where additional components are not provided—or it may be an opening 113 in an additional component. In the example of FIG. 5, the locator component 109 is provided at the distal end 112 of the consumable and comprises the opening 113 for the projection 206. The opening 113 of the locator component 109 is preferably sized to tightly abut the outer surface of the projection 206 when the consumable and device 200 are combined. Therefore, the wall 102 of the hollow section 101 may be spaced from the outer surface of the projection 206 all the way around the longitudinal axis of the consumable 100, with location being provided the locator component 109. The locator component 109 also negates the requirement for the outermost surface of the consumable 100 to tightly abut the wall 207 of the area 201 for receiving the consumable 100. In the example of FIG. 5 an additional locator component 109′ is disposed at the mouth end 111 of the consumable 100, in between the hollow section 101 and the filter plug 108. The filter plug 108 and locator components 109, 109′ may be made from cellulose acetate or paper materials. When the consumable 100 is fully inserted into the area 201, the mouth end protrudes from the area 201 to allow a user to draw on the consumable 100 in use.

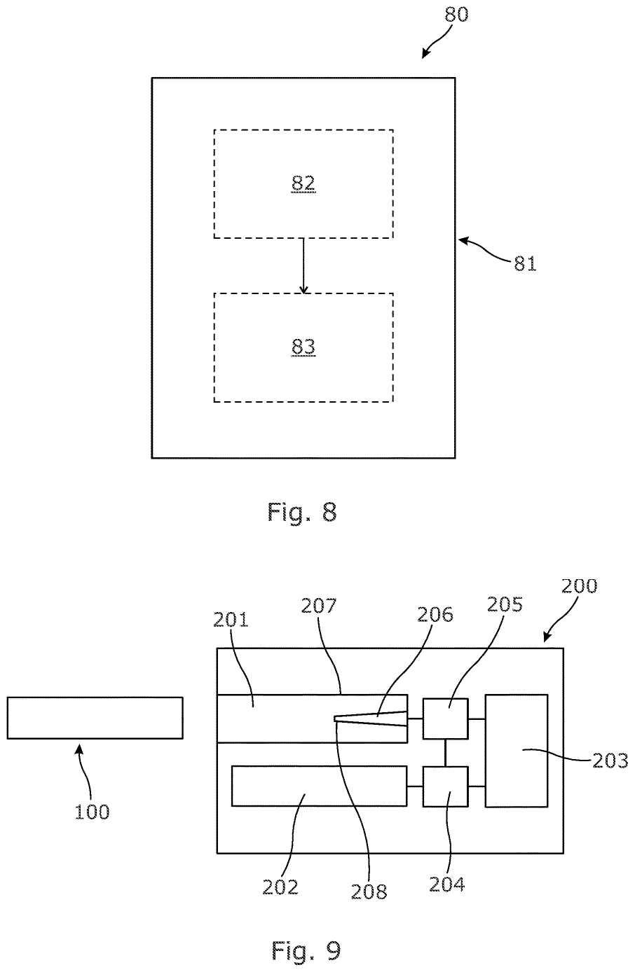

Referring to FIG. 8, there is shown a flow diagram showing an example of a method 80 of manufacturing a consumable 100 for use with the system of examples described herein. The method 80 of FIG. 8 is usable to manufacture any of the consumables 100 described herein.

The method comprises providing 81 the hollow section 101 comprising the support 104 and aerosol generating material 105 affixed to the support 104 and, optionally, attaching thereto any desired additional components.

In some examples, the providing 81 comprises affixing 82 the aerosol generating material 105 to the support 104, and then forming 83 the hollow section 101. Accordingly, in some examples, the support 104 may be flat or substantially flat at the time the aerosol generating material 105 is affixed to it. Thereafter, in some examples, the support 104 and aerosol generating material 105 may be manipulated together during formation of the hollow section 101. Such manipulation may comprise rolling or wrapping the combination of the support 104 and aerosol generating material 105 into a—typically tubular—section 101. However, it will be appreciated that the combination of the support 104 and aerosol generating material 105 may instead be folded into a section 101 having a non-circular cross section. Such rolling, wrapping or folding may be around a mandrel, for example. In other examples, the support 104 is provided in a tubular, or substantially tubular, form, and thereafter the aerosol generating material 105 is affixed to the support 104.

In some examples, the method comprises manufacturing the support 104. For example, and as discussed by way of some examples herein, the support 104 may comprise a plurality of layers 106, 107, and the manufacture of the support 104 may comprise assembling those layers to form the support 104, such as by adhesion. At least one of the layers 106, 107 may be in sheet or strip form.

In some examples, such as some of those in which the affixing 82 is performed before the forming 83, the affixing 82 comprises coating the aerosol generating material 105 onto the support 104 to form a film of aerosol generating material 105. Such coating may comprise spraying, electro-spraying, casting or band casting, for example. Such casting may involve providing material in liquid or other fluid form on a surface of the support 104 (or material that ultimately will form the support 104), and then allowing the material to at least partially solidify or cure on the surface of the support 104 to form the aerosol generating material 105 comprising the film. The material in liquid or other fluid form may be aerosol generating in that form, or may only become aerosol generating once it has solidified or cured.

In some examples, the affixing 82 may comprise a technique other than coating. For example, the affixing 82 comprises adhering the aerosol generating material 105 to the support 104 using an adhesive.

Should additional components be required-such as the components of the example of FIG. 5—then said components may be attached to the hollow section 101 by first arranging each of the components in axial alignment to form an assembly of components and then wrapping the components in a wrapping material 110. In the example of FIG. 5, said assembly comprises, in order, the distal end locator component 109, the hollow section 101, the mouth end locator component 109′ and the filter plug 108. Said assembly is then wrapped in the wrapping material 110 to form the consumable 100 of FIG. 5.

The aerosol generating material 105 of any of the examples described herein may comprise an aerosol former, a binder, optionally a filler and optionally an active and/or a flavorant.

1. A non-combustible aerosol provision system comprising a consumable and a non-combustible aerosol provision device, the non-combustible aerosol provision device comprising an aerosol generator configured to heat the consumable to generate an aerosol when, in use, the consumable and the device are combined, wherein the consumable comprises a hollow section, the hollow section comprising a support and a film of aerosol generating material coated on the support, the hollow section defining an air gap of the consumable in which aerosol is generated in use, and wherein the device comprises a projection configured for insertion into the air gap of the consumable when the device and consumable are combined.

2. A system according to claim 1, wherein the support is part of a wall of the hollow section that surrounds the air gap and the aerosol generating material forms an inner surface of the wall.

3. A system according to claim 2, wherein the hollow section is a hollow tube.

4. A system according to claim 3, wherein the support is a tubular wall of the hollow tube

5. A system according to claim 1, wherein the support forms at least part of a surface of the consumable.

6. A system according to claim 5, wherein the surface of the consumable is an outermost surface of the consumable.

7. A system according to claim 6, wherein the aerosol generating material forms an internal surface of the hollow section.

8. A system according to claim 7, wherein the device and consumable are configured so that an outer surface of the projection is spaced from the internal surface of the hollow section of the consumable when the device and the consumable are combined.

9. A system according to claim 1, wherein the cross sectional area of at least a portion of the projection occupies between 20% and 80% of the cross sectional area of at least a portion of the air gap when the device and the consumable are combined.

10. A system according to claim 1, wherein the projection is configured to occupy between 50% and 80% of the volume of the air gap when the device and the consumable are combined.

11. A system according to claim 1, wherein the aerosol generator comprises the projection.

12. A system according to claim 11, wherein the projection is configured to be heated in use.

13. A system according to claim 12, wherein the projection comprises a susceptor and wherein the aerosol generator further comprises a magnetic field generator for generating a varying magnetic field that penetrates the projection.

14. A system according to claim 1, wherein the consumable comprises a susceptor and wherein the aerosol generator comprises a magnetic field generator for generating a varying magnetic field that penetrates the susceptor.

15. A system according to claim 14, wherein the support comprises the susceptor.

16. A system according to claim 15, wherein the support comprises a first layer and a second layer, wherein the first layer comprises the susceptor, wherein the second layer is not heatable by penetration with a varying magnetic field, and wherein the first layer is located between the aerosol generating material and the second layer.

17. A system according to claim 16, wherein the second layer is outward of the first layer.

18. A system according to claim 17, wherein the second layer forms at least part of an outermost surface of the consumable.

19. A system according to claim 14, wherein the projection comprises a magnetic field generator for generating a varying magnetic field that penetrates the susceptor.

20. A system according to claim 13, wherein the susceptor comprises one or more materials selected from the group consisting of: an electrically-conductive material, a magnetic material, and a magnetic electrically-conductive material.

21. A system according to claim 11, wherein the projection is configured to be heated by electrical resistance.

22. A system according to claim 1, wherein the cross sectional area of the projection varies along its length.

23. A system according to claim 1, wherein the air gap of the consumable comprises discreet sections and the aerosol generator is configured to heat each of the discreet sections consecutively.

24. A system according to claim 1, wherein the aerosol-generating material comprises:
an aerosol former
a binder;
optionally a filler; and
optionally an active and/or a flavorant.

25. A system according to claim 24, wherein the aerosol generating material comprises an aerosol generating film and wherein the aerosol generating film is up to about 1 mm thick and, optionally, up to 500 microns thick and, optionally, 50 to 500 microns thick.
